(19) United States
(12) Patent Application Publication
(10) Pub. No.: US 2025/0160261 A1
(43) Pub. Date: May 22, 2025

(54) CORD REEL ASSEMBLY

(71) Applicant: Fiskars Finland Oy Ab, Espoo (FI)

(72) Inventors: Samuel FEMAL, Espoo (FI); Daniel LIPSCOMB, Espoo (FI)

(21) Appl. No.: 18/946,314

(22) Filed: Nov. 13, 2024

Related U.S. Application Data
(60) Provisional application No. 63/599,897, filed on Nov. 16, 2023.
(60) Provisional application No. 63/599,893, filed on Nov. 16, 2023.

(51) Int. Cl. A01G 3/08; B25G 1/04; B25G 3/28; B65H 75/48

(52) U.S. Cl. CPC A01G 3/081; B65H 75/48; B25G 1/04; B25G 3/28

(57) ABSTRACT

A cord reel assembly for a tree pruner having a pole, comprising an outer housing which is divided into a first and a second half, the first half comprising a pole connection mechanism having a male connection part with an insert, the insert is adapted to engage with a locking pin of the pole, for locking the cord reel in place to the pole.

This application claims the priority benefits of U.S. Provisional Patent Application Ser. No. 63/599,897, filed Nov. 16, 2023, for “Cord reel”, and U.S. Provisional Patent Application Ser. No. 63/599,893, filed Nov. 16, 2023, for “Handle”, the content of which is hereby incorporated by reference in its entirety.

### BACKGROUND

The invention relates to a cord reel assembly, and especially to a cord reel adapted for tree pruners with a pole.

A conventional tree pruner with a cord is usually used when trying to reach on branches located high above the ground. By pulling the cord or rope from one end of the pole, the pulling motion is transferred to the cutting head at the opposite end as a cutting motion, for example by closing a blade. However, the cord may dangle and become twisted, or the cord may tangle with other branches, which causes the user additional time and energy to disentangle.

### BRIEF DISCLOSURE

An object of the invention is thus to provide an arrangement that solves or at least alleviates the aforementioned challenges. The invention is based on providing a cord reel assembly which keeps the cord tight and close to the pole all the time, until the user wants to utilise the cutting motion.

### BRIEF DESCRIPTION OF THE DRAWINGS

The invention will now be described in more detail in connection with preferred embodiments and with reference to the accompanying drawings, in which:

FIG. 1 illustrates a diagonal top view of a cord reel assembly according to an embodiment;

FIG. 2 illustrates a longitudinal side view of the cord reel assembly of FIG. 1;

FIG. 3 illustrates a front view of the cord reel assembly of FIG. 1;

FIG. 4 illustrates an exploded view of contents inside an outer housing of the embodiment;

FIG. 5 illustrates a diagonal top view of a cord reel assembly according to another embodiment;

FIG. 6 illustrates a longitudinal side view of the cord reel assembly of FIG. 5;

FIG. 7 illustrates a top view of the cord reel assembly of FIG. 5;

FIG. 8 illustrates cord reel assembly insertion into a pole;

FIG. 9 illustrates cord reel assembly assembled with the pole;

FIG. 10 illustrates a closer view of a locking mechanism in the locked state;

FIG. 11 illustrates a closer view of a locking mechanism in a secondary locking region.

### DETAILED DESCRIPTION OF EMBODIMENTS

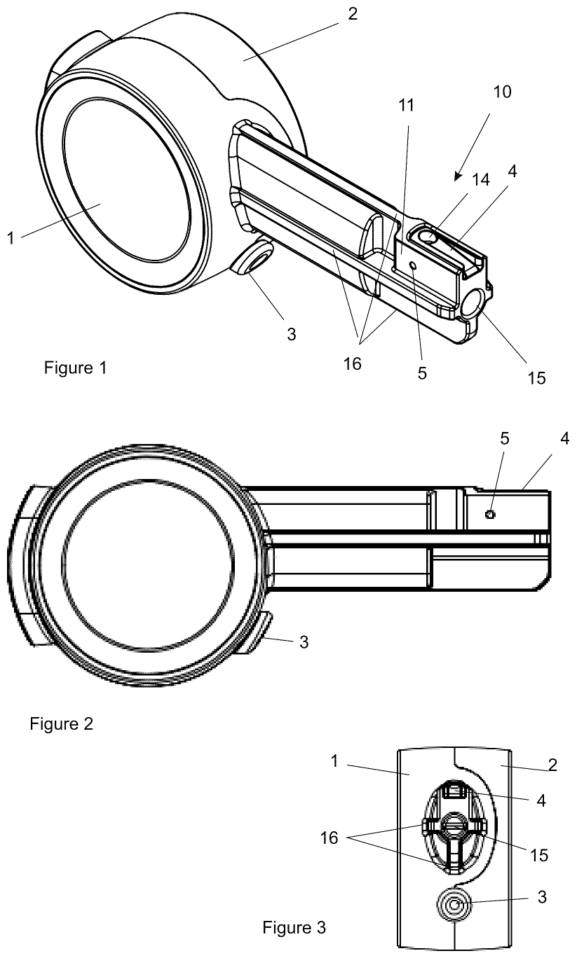

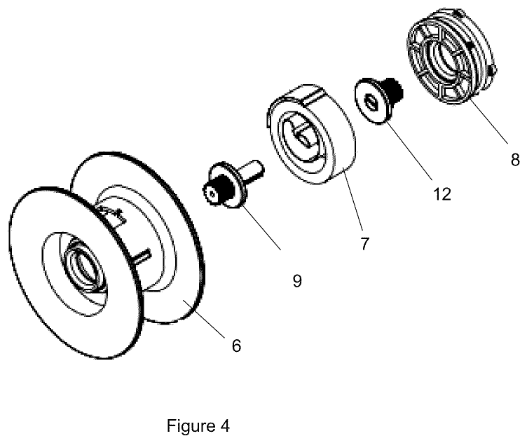

FIG. 1 illustrates a diagonal top view of a cord reel assembly according to an embodiment. FIG. 2 illustrates a longitudinal side view of the cord reel assembly, and the FIG. 3 illustrates a front view of the cord reel assembly. FIG. 4 illustrates an exploded view of contents inside an outer housing of the embodiment.

The cord reel assembly is designed for a tree pruner having a pole or a telescopic pole. The pole can be hollow. The cord reel assembly comprises an outer housing, which is divided into a first half 1 and a second half 2. The outer housing can be made of plastic. The first and second halves 1,2 may be connected to each other at least partially at a longitudinal vertical plane with fasteners, such as screws. The first half 1 comprises a pole connection mechanism 10 having a male connection part 11 with an insert 4, which can be a metal insert. The first half 1 and the second half 2 may comprise identical cup portions. The outer housing can be in a shape of a cylinder to fit a cord drum 6 and the pole connection mechanism 10 protrudes from a rim of the cylinder so that the cord reel assembly resembles a shape of a whistle.

The cord reel assembly may further comprise a cord drum 6, which houses the cord (not shown), a coil spring 7 and a coil locking cap or a coil locking plate 8 inside the first half 1 and the second half 2. The coil spring 7 can be for example a spiral spring. The cord drum 6 may have a hollow cylindrical interior space that houses the coil spring 7. The locking plate 8 prevents the coil spring 7 from dissociating from the cord drum 6. The coil spring 7 may be fastened to the cord drum 6 and the coil locking plate 8 with a spring tightener insert 9 and a spring tightener insert cap 12. However, other known cord drum and spring solutions may be implemented.

The spring tightener insert 9 may have a thin cylindrical body with a small slot at the top protruding from the right side of the outer housing fits through the cord drum 6 and engages with the coil spring 7, creating tension on the cord causing self-retraction when let go of the extended cord.

The cord reel assembly may further comprise a third component as a cord guide 3, allowing smooth exiting of a cord from the cord reel assembly, wherein the cord guide 3 is arranged below the pole connection mechanism 10. That way the cord stays as close as possible to the pole and also prevents the cord twisting around the pole when a cord end is connected to a cutting unit of the tree pruner. The cord guide 3 can be an opening with reinforced or rounded edge or a separate component attachable to the opening.

The insert 4 is adapted to engage with a locking mechanism 22 of the pole, and arranged to lock the cord reel assembly in place to the pole. The insert 4 may comprise a ramped channel 13 leading upward to a cylindrical pocket 14. This ramped channel 13 is arranged to accept a locking pin 24 on a spring-loaded button found on the female connection part 23 of the locking mechanism 22 which will be addressed later.

The pole connection mechanism 10 may comprise a pin 5, which locks the insert 4 to the male connection part 11. The male connection part 11 can be made of plastic and the insert 4 made of stainless steel or carbon steel, for example. The cross-section of the pole connection mechanism 10 can be oval or circular, and it can have a hollow or solid or semi-solid inside. The male connection part 11 may also comprise a section between the insert 4 and the cylinder where the cross-section resembles a cross.

The interface between the first half 1 and the second half 2 may be located at a distance away from the pole connection mechanism 10 and not touch the pole connection mechanism 10.

A distal end of the pole connection mechanism 10 may comprise an aperture 15 below the insert 4. The aperture 15 provides more rigidity to the structure and may accommodate a screw. The aperture 15 also provides weight saving and an aesthetic design.

The pole connection mechanism 10 may further comprise one or more ribs 16 at the top, bottom or sides of the pole connection mechanism 10, which may partially form the cross cross-section mentioned above. The rib 16 facilitates guiding and aligning the cord reel assembly into the correct position inside the pole. The four ribs 16 fit through corresponding slots (not shown) on the female connection part 23 to help with alignment. The male connection part 11 and the first half may be manufactured together in one manufacturing step, for example during casting or moulding. The cross cross-sectional geometry also provides stability. These ribs also have small tolerance gaps between their outer faces and the inner face of the larger outer pole. These small gaps allow for a tighter, more robust fit between the pole and the cord reel assembly.

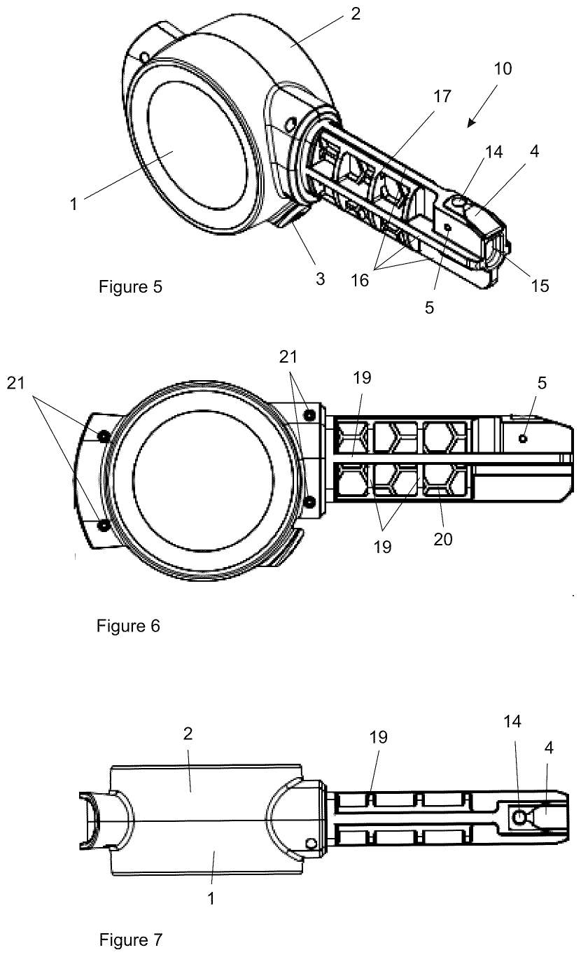

FIG. 5 illustrates a diagonal top view of a cord reel assembly according to another embodiment. FIG. 6 illustrates a longitudinal side view of the cord reel assembly of FIG. 5. FIG. 7 illustrates a top view of the cord reel assembly of FIG. 5. The embodiment of FIGS. 5-7 is very similar to the one explained in connection with FIGS. 1-4. Therefore, the embodiment of FIGS. 5-7 is in the following mainly explained by pointing out differences.

The pole connection mechanism 10 may comprise a grid 17 comprising a middle horizontal plate 18 and vertical columns 19 defining rectangular through-holes. The middle horizontal plate 18 may have similar thickness and/or length as the rib 16 of the first embodiment. The vertical column 19 may have smaller thickness than the middle horizontal plate 18. The grid 17 may comprise one middle horizontal plate 18 and two or more vertical columns 19 on each side of the middle horizontal plate 18 so that there is same number of vertical columns 19 on both sides. The grid 17 may further comprise a honeycomb structure 20 for additional support. The honeycomb structure 20 may be arranged inside the rectangular through-holes and manufactured together with the male connection part 11 in one manufacturing step, for example during casting or moulding.

The interface between the first half 1 and the second half 2 may be located at the middle of the pole connection mechanism 10 so that the second half 2 comprises partially the proximal end of the pole connection mechanism 10. At least one housing screw 21 can be used to attach the first half 1 and the second half 2 together. Two housing screws 21 may be located at the proximal end of the pole connection mechanism 10 and two housing screws 21 may be located at the back of the cord reel assembly opposite the male connection part 11.

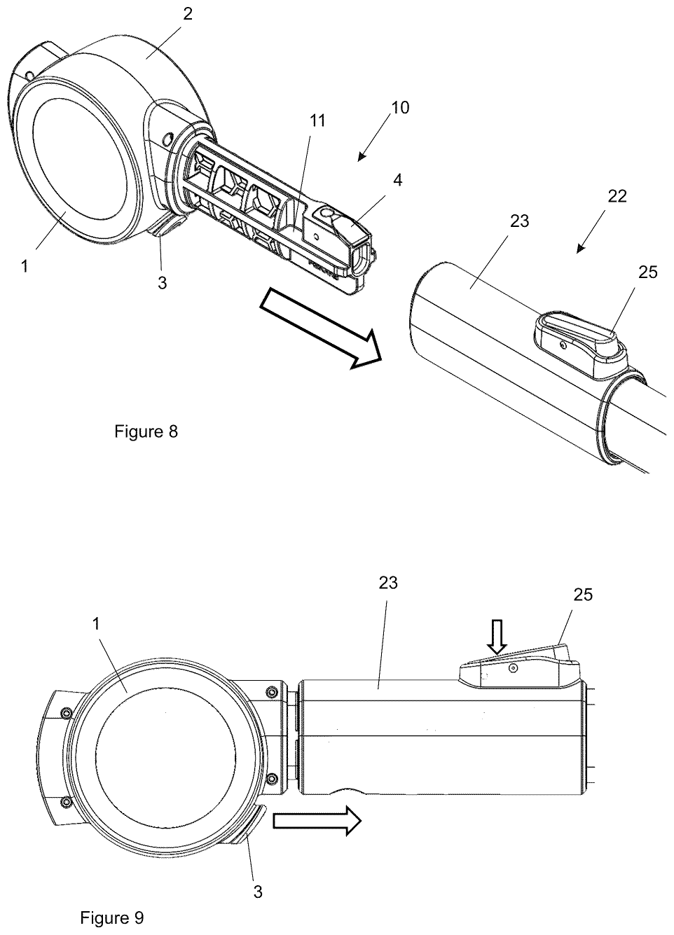

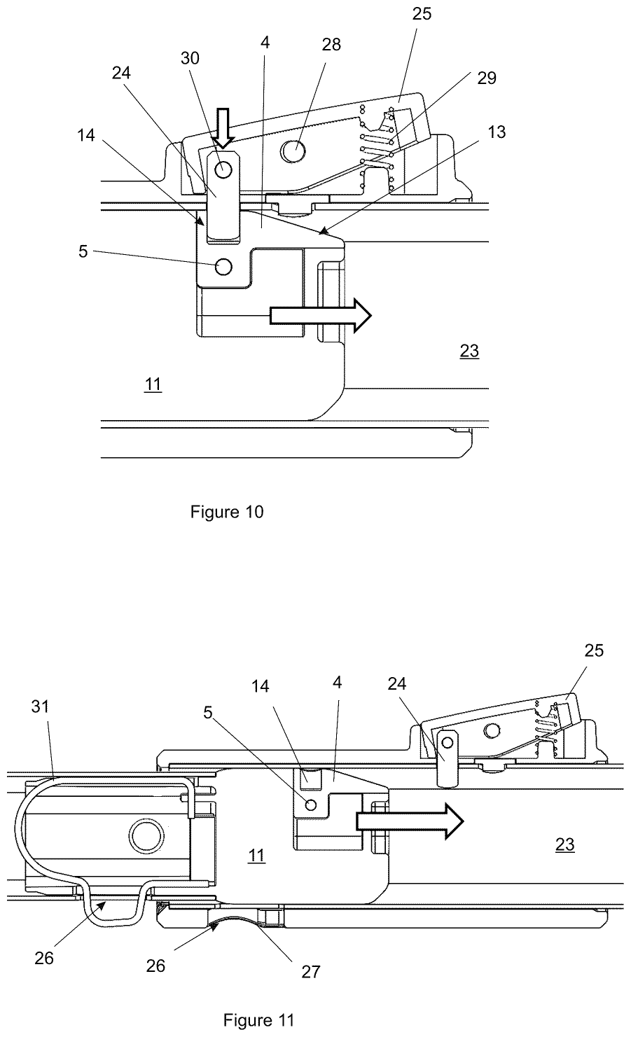

FIG. 8 illustrates the cord reel assembly insertion into a pole. FIG. 9 illustrates cord reel assembly assembled with the pole. FIG. 10 illustrates a closer view of a locking mechanism in the locked state.

The present invention further pertains to a pole of a tree pruner. The pole can be at least partially hollow, and it can have a circular or oval cross-section. It can be a telescopic pole. The pole comprises a locking mechanism 22 at one end of the pole adapted to receive the pole connection mechanism 10 of the cord reel assembly. The locking mechanism 22 can be broken into three distinct regions: the pole attachment region, the primary locking region, and the secondary locking region. The secondary locking region 27 may be optional.

The pole attachment region may define a female connection part 23 adapted to receive the male connection part 11 of the cord reel assembly in a male-female connection. The pole attachment region is the area in which the female connection part 23 of the locking mechanism 22 is attached to the pole or outer pole. The female connection part 23 can be found on the bottom end of the pole, or the outer pole within one of the telescoping pole assemblies. The female connection part 23 may surround almost the whole pole connection mechanism 10 so that there is only a small gap, 0.05-2 mm or 0.002-0.08 inch, between the rim and the female connection part 23.

The female connection part 23 may be made of plastic which features a unique “U” shaped pocket that aligns with a thru-hole on the top of the outer pole. The male connection part 11 with the same “U” shape geometry with a cylindrical protrusion is seated into the female connection part's 23 pocket with its cylindrical protrusion seating in the outer pole's thru-hole.

The primary locking region may be protruded from the female connection part 23 and may comprise a spring-loaded button 25 and a locking pin 24 construct that engages with the aforementioned ramped channel 13 and cylindrical pocket 14 in the insert 4 found on the male connection part 11 of the pole connection part 10 to lock the cord reel assembly and the pole together. The spring-loaded button 25 and the locking pin 24 construct may comprise a spring-loaded release button 25, a central button axial pin 28, a button spring 29, a locking pin 24, and an axial pin 30 for the locking pin.

The locking pin 24 may be arranged to lock onto the cylindrical pocket 14 of the insert 4 of the cord reel assembly. The locking pin 24 may have a circular circumference with a smaller diameter than the cylindrical pocket 14. The locking pin 24 is arranged to pass through the pole attachment region. When inserting the male connection part 11 into the female connection part 23, the locking pin 24 is arranged to slide along the ramped channel 13 to the cylindrical pocket 14.

By pressing the spring-loaded release button 25 against the spring force, the locking pin 24 from the cylindrical pocket 14 is released by lifting the locking pin 24. The spring force keeps the spring-loaded release button 25 upward and the locking pin 24 downward, wherein downward means closer to the interior of the pole. The locking mechanism 22 may comprise two button springs 29, one contacting the spring-loaded release button 25 and another contacting the locking pin 24.

In another embodiment, there may be a second locking mechanism. FIG. 11 illustrates a closer view of the locking mechanism 22 in a secondary locking region 27. In the accompanying Figures, the primary locking region is illustrated at the top of the locking mechanism 22 and the secondary locking region 27 is illustrated at the bottom of the locking mechanism 22. This helps the user to see and find the primary locking region. The pole connection mechanism 10 of the cord reel assembly may further comprise a spring wire 31 that may be fixed to the inside the pole connection mechanism 10. The spring wire 31 may be formed into a “C” shape with a protrusion on its bottom which protrudes through two machined slots 26, one at the bottom part of the male connection part 11 and one at the bottom part of the pole of the female connection part 23 of the locking mechanism 22.

The female connection part's 23 secondary locking region doesn't consist of specific components but rather features on certain components. The outer pole has the slot 26 to accommodate the aforementioned spring wire 31 found on the male connection part 11 of the locking mechanism 10. Additionally, the female connection part 23 features a similar slot 26 and raised “C” shaped protrusion that functions as a protective feature for the spring wire 31, preventing accidental bumping of the wire during usage and consequential disengagement of the secondary locking region 27.

In order to connect the cord reel assembly and the pole together, the male connection part 11 of the pole connection mechanism 10 is inserted into the base of the female connection part 23 of the of the locking mechanism 22. As the male connection part 11 is inserted, the spring wire 31 makes contact with the base of the female connection part 23, pushing the spring wire 31 inwards, allowing the male connection part 11 to continue to move further inward in the base of the female connection part 23 of the pole. Once the male connection part 11 travels far enough, the spring wire 31 pops through slots 26 in both the outer pole and the pole connection mechanism 10 at its original position relative to its associated male connection part 11, effectively achieving a locked state at the secondary locking region 27.

Meanwhile, as the male connection part 11 continues to travel further into the base of the pole, the ramped channel 13 on the insert 4 will make contact with the locking pin 24 found on the spring-loaded release button 25 on the female connection part 23. Given the angled form of the insert's 4 ramped channel 13, the locking pin 24 will slowly be pushed upwards, feeling resistance from the button spring 29 as the male connection part 11 travels further inward. Once reaching the end of the ramped channel 13, the locking pin 24 will spring downwards into the insert's 4 cylindrical pocket 14, effectively achieving a locked state of the primary locking region.

The present invention further pertains to a tree pruner with any of the cord reel assembly embodiments described above. The tree pruner comprises a pole having a cutting unit (not shown) at one end and the locking mechanism 22 at an opposite end, wherein the locking mechanism 22 comprises the female connection part 23, and the spring-loaded button 25 with the locking pin 24 as described above. The cutting unit can be any type of assembly for cutting a branch of a tree. The tree pruner further comprises the cord reel assembly comprising the outer housing, which is divided into the first half 1 and the second half 2. The first half 1 comprises the pole connection mechanism 10 having the male connection part 11 with the insert 4, wherein the insert 4 is engageable with the locking pin 24 of the pole for the male-female connection.

One end of the cord from the cord reel assembly may be fastened to the cutting unit with a cutting blade so that when the user pulls the cord away from the cutting unit the cutting blade makes a cutting motion. The coil spring 7 inside the cord drum 6 of the cord reel assembly keeps the cord lightly tensioned so that the cord does not dangle or get loose even during the cutting motion. When the user releases the cord, the cutting blade returns to the initial position and the cord is retracted back close to the pole.

With the present invention, the cord stays always slightly tensioned and close to the pole so that it will not get tangled with leaves or twigs when the user is navigating the tree pruner to the correct position. The detachable cord reel assembly is also easily replaceable in case of accidents, where the outer housing breaks or the cord gets severed.

Those of ordinary skill in the art may recognize that modifications of the embodiments disclosed herein are possible. For example, different materials may be used. The outer design of the housing may vary. Other modifications may occur to those of ordinary skill in this art, and all such modifications are deemed to fall within the purview of the present invention, as defined by the claims.

### REFERENCE NUMBERS

1 first half
2 second half
3 cord guide
4 insert
5 pin
6 cord drum
7 coil spring
8 coil locking plate
9 spring tightener insert
10 pole connection mechanism
11 male connection part
12 spring tightener insert cap
13 ramped channel
14 cylindrical pocket
15 aperture
16 rib
17 grid
18 middle horizontal plate
19 vertical column
20 honeycomb structure
21 housing screw
22 locking mechanism
23 female connection part
24 locking pin
25 spring-loaded release button
26 slot
27 secondary locking region
28 central button axial pin
29 button spring
30 axial pin
31 spring wire

1-20. (canceled)

21. A cord reel assembly for a tree pruner having a pole, comprising
an outer housing, which is divided into a first and a second half,
the first half comprising a pole connection mechanism having a male connection part with an insert, the insert is adapted to engage with a locking mechanism of the pole, for locking the cord reel in place to the pole.

22. The cord reel assembly according to claim 21, wherein the pole connection mechanism comprises a pin, which locks the insert to the male connection part.

23. The cord reel assembly according to claim 21, wherein cord reel assembly further comprises a cord drum, which houses the cord, a coil spring and a coil locking plate.

24. The cord reel assembly according to claim 23, wherein the cord drum has a hollow cylindrical pocket that houses the coil spring.

25. The cord reel assembly according to claim 23, wherein the locking plate prevents the coil spring from dissociating from the cord drum.

26. The cord reel assembly according to claim 21, wherein the outer housing is in a shape of a cylinder and the pole connection mechanism protrudes from a rim of the cylinder.

27. The cord reel assembly according to claim 21, wherein the cord reel assembly further comprises a cord guide allowing smooth exiting of a cord from the cord reel assembly, wherein the cord guide is arranged below the pole connection mechanism.

28. The cord reel assembly according to claim 21, wherein a distal end of the pole connection mechanism comprises an aperture below the insert.

29. The cord reel assembly according to claim 21, wherein the insert comprises a ramped channel leading upward to a cylindrical pocket.

30. The cord reel assembly according to claim 21, wherein a spring wire is fixed inside the pole connection mechanism.

31. The cord reel assembly according to claim 21, wherein the pole connection mechanism comprises a grid comprising a middle horizontal plate and vertical columns defining rectangular through-holes.

32. The cord reel assembly according to claim 31, wherein the grid further comprises a honeycomb structure for additional support.

33. A tree pruner pole, comprising
a locking mechanism at one end adapted to receive a pole connection mechanism of a cord reel assembly according to claim 21.

34. The tree pruner pole according to claim 33, wherein the locking mechanism comprises a spring-loaded release button and a locking pin.

35. The tree pruner pole according to claim 34, wherein the locking mechanism comprises a central button axial pin, a button spring, and an axial pin for the locking pin.

36. The tree pruner pole according to claim 33, wherein the pole is hollow, and the locking mechanism comprises a female connection part, arranged to receive the pole connection mechanism in a male-female connection.

37. The tree pruner pole according to claim 33, wherein the locking mechanism comprises a secondary locking region.

38. The tree pruner pole according to claim 37, wherein the secondary locking region comprises a slot located at a bottom of the locking mechanism.

39. A tree pruner, comprising
a pole having a cutting unit at one end and a locking mechanism at an opposite end,
the locking mechanism comprises a female connection part, and a spring-loaded button with a locking pin,
and a cord reel assembly comprising an outer housing, which is divided into a first and a second half, the first half comprising a pole connection mechanism having a male connection part with an insert, the insert is engageable with the locking pin of the pole for a male-female connection.

40. The tree pruner according to claim 39, wherein the pole is a telescopic pole.

41. The tree pruner according to claim 39, wherein one end of the cord from the cord reel assembly is fastened to the cutting unit.
